(19) United States
(12) Patent Application Publication
(10) Pub. No.: US 2014/0053081 A1
(43) Pub. Date: Feb. 20, 2014

(54) SYSTEM AND METHOD FOR THE REAL-TIME DISPLAY OF IMAGES IN CONJUNCTION WITH OBJECTS ON A GRAPHICAL USER INTERFACE

(71) Applicant: Fotobar, LLC, Boca Raton, FL (US)

(72) Inventors: Warren Struhl, Boca Raton, FL (US); Nathanael F. Pelton, Rockville, MD (US)

(21) Appl. No.: 13/870,529

(22) Filed: Apr. 25, 2013

Related U.S. Application Data
(60) Provisional application No. 61/683,833, filed on Aug. 16, 2012.

(51) Int. Cl. H04L 12/58

(52) U.S. Cl. CPC H04L 51/28
USPC 715/752

(57) ABSTRACT

A system for the real-time displaying of images includes a web server accessed by a plurality of users via a global communication network. The web server has an IP address associated with a domain and the server includes an email address generator providing a unique email address to which a user may send digital images and a mail server receiving email messages. The mail server includes a “catch-all” email account receiving all email for the IP address that does not match an existing email account of the domain and a time based job scheduler initiating checks for any new emails within the “catch-all” email account. The system identifies emails addressed to the unique email address and determines if the email has any valid digital image file attached thereto and then downloads any valid digital image files from the mail server to the web server for viewing by the user on the webpage in real time.

### CROSS REFERENCE TO RELATED APPLICATION

This application claims the benefit of U.S. Provisional Application Ser. No. 61/683,833, entitled “SYSTEM AND METHOD FOR USING SMTP FOR AUTOMATICALLY DISPLAYING ONE OR MORE IMAGE FILES ON AN HTML PAGE,” filed Aug. 16, 2012.

### BACKGROUND OF THE INVENTION

1. Field of the Invention

This invention relates to a system and method for the real-time display of images upon a graphic user interface of a browser being run upon a computing device. More particularly, the system and method relate to the real-time display of digital images in conjunction with various objects displayed on a website in a manner allowing a user to view a digital image provided by the user upon, for example, a coffee mug or picture frame they might wish to purchase.

2. Description of the Related Art

Various websites offer consumers with the opportunity to purchase customized products. These products may be customized with pictures, logos or other artwork provided by the user to the operator of the website. However, these websites have difficulty in allowing the consumers to preview the products with the pictures, logos or other artwork.

The present invention provides a system and method for addressing these problems to provide a preview system for customized goods.

### SUMMARY OF THE INVENTION

It is, therefore, an object of the present invention to provide a system for the real-time display of images. Thee system includes a web server accessed by a plurality of users via a global communication network. The web server having an IP address associated with a domain. The web server also includes an email address generator providing a unique email address to which a user may send digital images. The system also includes a mail server receiving email messages, the mail server including a “catch-all” email account receiving all email for the IP address that does not match an existing email account of the domain and a time based job scheduler initiating checks for any new emails within the “catch-all” email account. The mail server also including a mechanism for identifying emails addressed to the unique email address and determining if the email has any valid digital image file attached thereto. The system further includes a mechanism for downloading any valid digital image files from the mail server to the web server for viewing by the user on the webpage in real time.

It is also an object of the present invention to provide a system wherein users view images upon a graphic user interface of a browser being run upon a computing device.

It is another object of the present invention to provide a system wherein the viewing by the user on the webpage is upon an object displayed upon the webpage.

It is a further object of the present invention to provide a system wherein the object is a picture frame.

It is also an object of the present invention to provide a system wherein the web server includes hardware, a database, an operating system, web server software, TCP/IP protocols and site content.

It is another object of the present invention to provide a system wherein within the database of the web server are maintained various user accounts associated with the unique email addresses generated by the email address generator of the web server.

It is a further object of the present invention to provide a system wherein the user accounts also maintain data relating to the objects selected for viewing by the user.

It is also an object of the present invention to provide a system wherein mail server is an SMTP server.

It is another object of the present invention to provide a system wherein the mail server includes a time based job scheduler initiating checks for new emails within the “catch-all” email account.

It is a further object of the present invention to provide a method for real-time display of images. The method includes receiving, by a web server, a request to view images on a website; generating a unique email address associated with a user account and providing the unique email address to a user wishing to view images on a website; receiving, by a mail server, an email addressed to the unique email address including images; and downloading the images from the mail server to the web server and associating the images with the user account for viewing on the website.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a flow chart disclosing the present methodology.

FIG. 2 is a schematic representation of the present system.

FIGS. 3-12 are various screenshots showing representative steps associated with the use of the present system.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

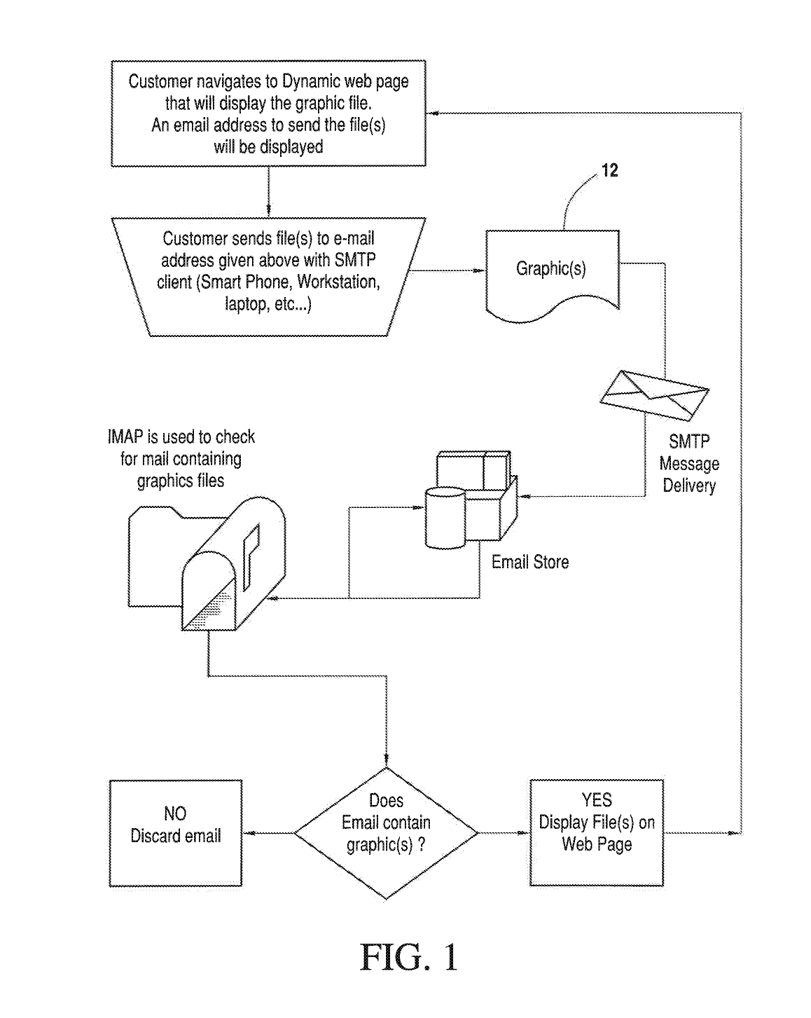

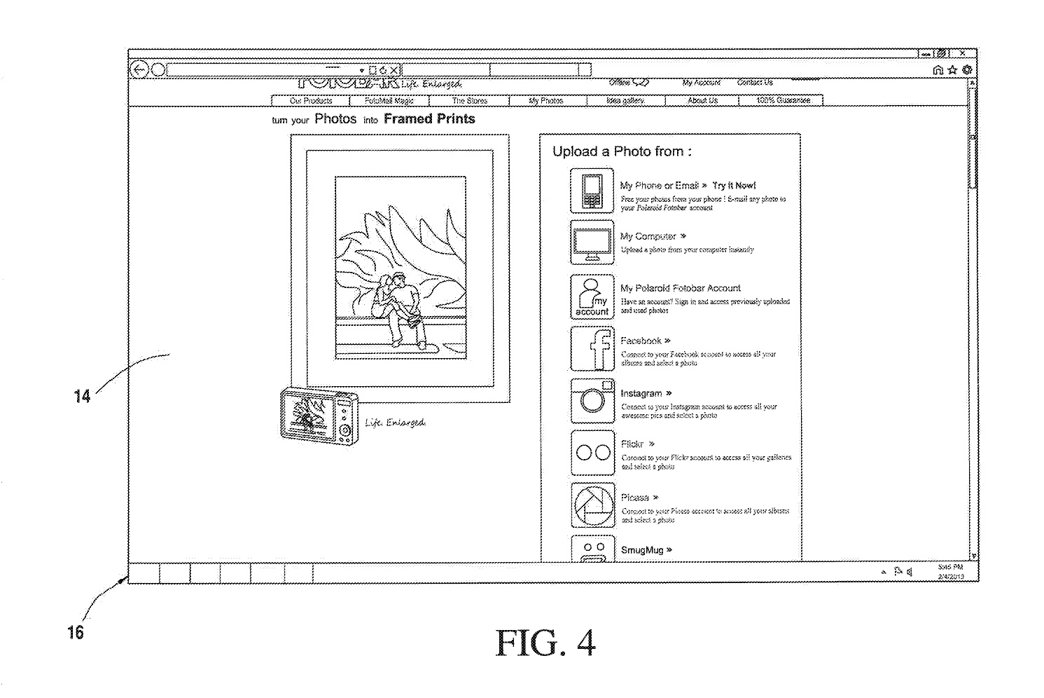

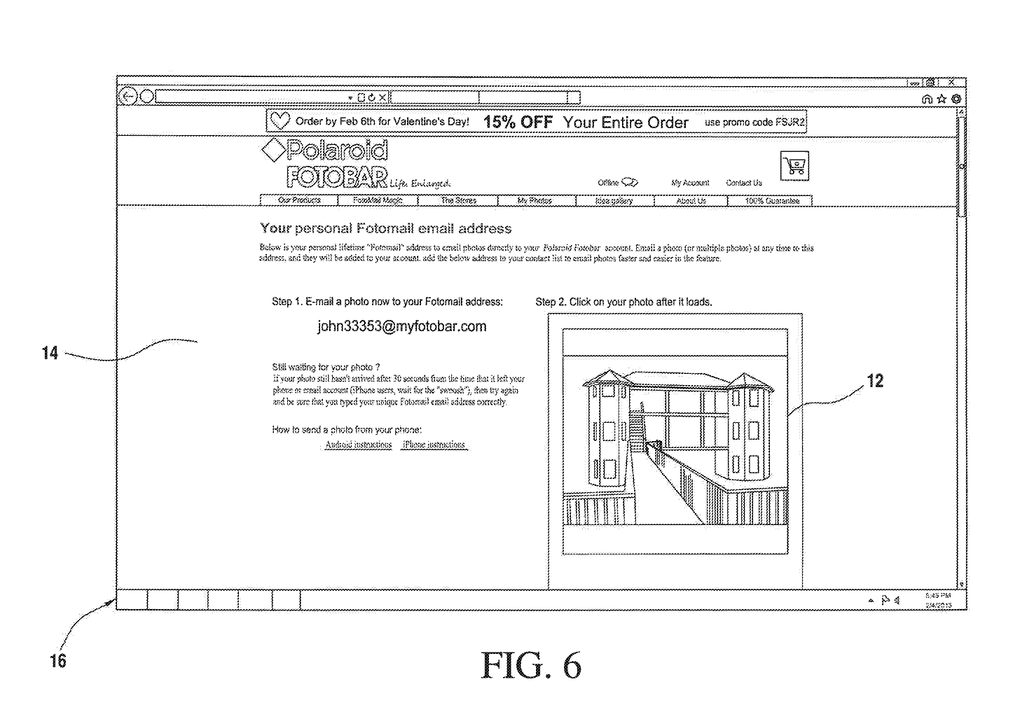

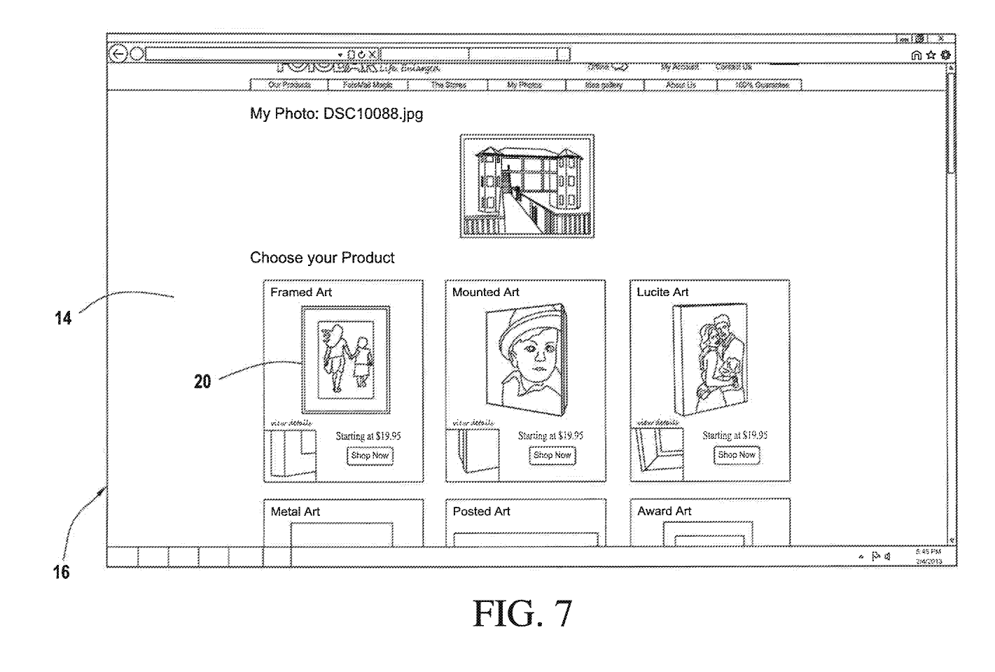

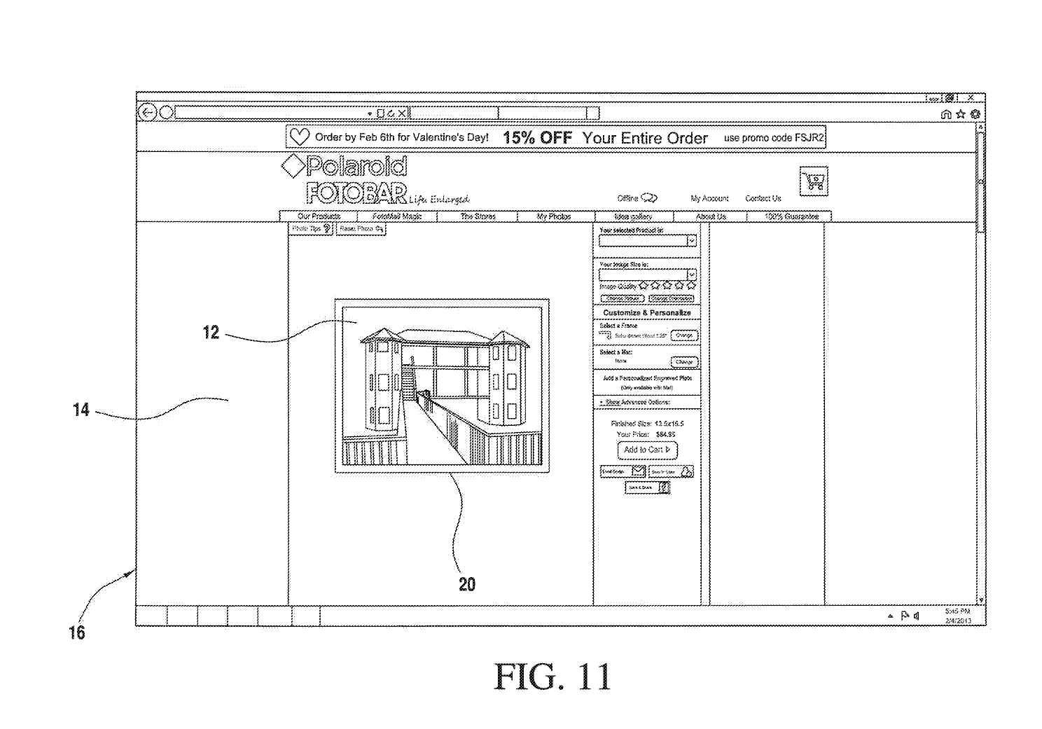

Referring to FIGS. 1 to 12, a system 10 and method are disclosed for the real-time display of images 12 upon a graphic user interface 14 of a browser 16 being run upon a computing device 18. More particularly, the system 10 and method relate to the real-time display of digital images 12 (see FIG. 6) in conjunction with various objects 20 displayed by the web server 22 (see FIGS. 7 and 11). For example, the system 10 and method allow a user 28 to view a digital image 12 provided by the user 28 upon a coffee mug they might wish to purchase. Similar, and with reference to the screen shots presented below in describing operation of the present system,the system 10 and method allow a user 28 to view a digital image 12 provided by the user 28 within a picture frame 20 they might wish to purchase. It is appreciated the image being viewed is any digital image 12 in the possession of the user 28. As such, the image may be stored in various digital formats known to those skilled in the art. By providing users with the ability to see the digital image 12 on the object 20 users are provided an opportunity to see exactly what the final product they may purchase will look like before purchasing.

As will be appreciated based upon the following disclosure, the present system 10 uses an email process that displays the digital image 12 sent on a page in real-time. Once a user has employed the present system 10 to upload one or more photos, graphic design or other digital image to their account, the image(s) that is displayed is only the image(s) that was sent (see FIG. 6), it is not yet layered onto the product. That comes in a later step since users are allowed to edit the image before they are shown the image in conjunction with the product 20.

In particular, and with reference to FIG. 1, a user 28 navigates to a webpage in order to display a graphic (for example, a digital image) 12 in that webpage for further use. On the webpage the user 28 is provided a unique email address 60 to send their graphic file 28. The email address 60 is comprised of the user's first name and their account number, ending with the proper domain (example:joe.F33335@asite.com). The customer is instructed to send the graphic(s) 12 they would like to display to this email address 60. The graphic(s) file 12 is sent to an SMTP server 26 using the SMTP protocol using any SMTP client, such as a smart phone, or personal computer. The SMTP file with the attachment(s) is then stored in a “catchall” email account 50 which receives all email for that domain that doesn't match an existing email account. When the user 28 emails photos to their unique email address 60 there is a CRON 52 that starts a process on the SMTP server 26 which checks the “catch-all” email account 50 for any new emails. Once it finds an email with a “to” that matches an account it checks to see if the email has any attached graphic file(s). The attached graphic file(s) 12 are downloaded from the SMTP server 26 to the web server 22. The process determines if it's a valid image format. If it is then it creates and displays the image for the purposes on the website. A database record is created for each uploaded graphic file indicating which customer it belongs to and what folder on the web server 22 will store the files. Thereafter the digital image 12 of the graphic file may be shown in conjunction with an object 20 on the web page.

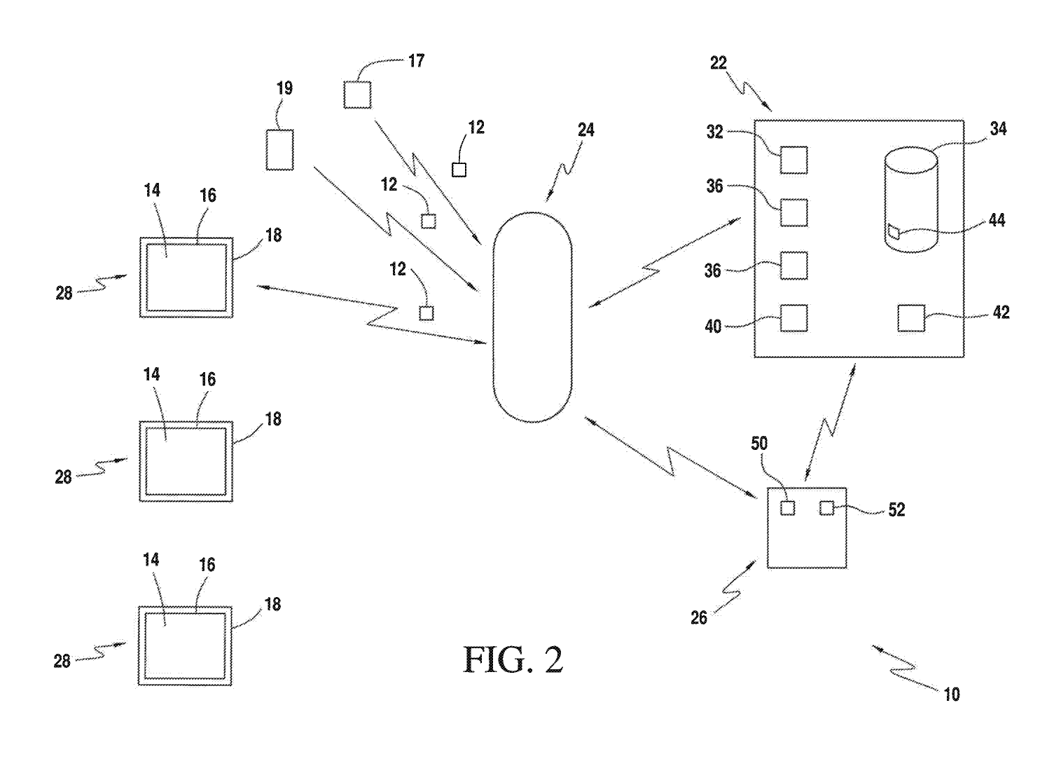

Referring to FIG. 2, the system 10 includes a web server 22 accessed by a plurality of users 28 via a global communication network 24. The web server 22 interacts with an SMTP server 26 to allow users 28 to email digital images 12 for real-time viewing via the web server 22. Briefly, and as will be appreciated based upon the following disclosure, the web server 22 receives a request from a user 28 to view a digital image 12 in conjunction with an object 20 that may be purchased via the website. Based upon this request, the web server 22 generates a unique email address associated with a user's account 44 and provides the unique email address to a user 28 wishing to view a digital image 12 in conjunction with various objects 20 for sale on a website. Thereafter, the user 28 attaches and sends the digital image 12 to the unique email address. The digital image 12 may be sent by the computer 18, digital camera 17 or smart phone 19. The email, with the attached digital image 12, is received by the SMTP server 26 and the digital image 12 is downloaded from the SMTP server 26 to the web server 22 where they are associated with the user's account 44 for viewing in real time by the user 28 on the browser 16 actively displaying the website.

As mentioned above, the system 10 includes a web server 22 communicating with a plurality of users 28 via a global communication network 30. The web server 22 is a traditional web server functioning to delivers Web pages to browsers as well as other data files to Web-based applications. As such, and without limitation, the web server 22 includes hardware 32, a database 34, an operating system 36, web server software 38, TCP/IP protocols 40 and site content (i.e., web pages, images and other files). As will be appreciated based upon the following disclosure, the web server 22 includes an IP address associated with a domain served by the web server 22. The web server 22 also includes an email address generator 42 providing a unique email address to which a user 28 may send digital images 12 in a manner discussed below in greater detail.

Within the database 34 of the web server 22 are maintained various user accounts 44. These user accounts 44 are associated with the unique email addresses generated by the email address generator 42 of the web server 22. The user accounts 44 also maintain data relating to the objects 20 selected for viewing by the user 28, as well as other data considered relevant by operators of the present system 10 in their implementation of the present system 10.

The system 10 also includes an SMTP (Simple Mail Transfer Protocol) server 26 receiving email messages directed to the domain served by the web server 22. It is appreciated the SMTP server 26 may be a stand-alone unit or may be integrated with the web server 22. As those skilled in the art appreciate, SMTP is a TCP/IP protocol used in sending and receiving e-mail messages.

The SMTP server 26 includes a “catch-all” email account 50 to which all e-mails, addressed to a non-available or mistakenly entered email account at the domain of the web server are routed. For example, if someone sends an email to info@yourdomain.com and you do not have such mailbox, the catch-all functionality of the SMTP server 26 will forward this email to the default, “catch-all” email account 50. Various applications are available for such functionality and it is appreciated these may be used in achieving the goals of the present invention. As such, when the email and the attached digital image 12 are sent to the unique email address, for which no actual email account has been established at the SMTP server 26, these emails will be forwarded to the “catchall” email account 50.

The SMTP server 26 is also provided with a time based job scheduler (CRON) 52 initiating checks for new emails within the “catch-all” email account 50. CRON 52 is driven by a crontab (cron table) file, a configuration file that specifies shell commands to run periodically on a given schedule. The crontab files are stored where the lists of jobs and other instructions to the cron daemon are kept. In accordance with the present invention the CRON 52 initiates periodic checks (for example, every few seconds) of the SMTP server 26 to identify new emails in the “catch-all” email account 50. The SMTP server 26 further includes an identification application allowing the SMTP server 26 to determine whether the new emails are associated with a user account 44 and whether the email includes a digital image 12 that may be downloaded from the SMTP server 26 to the web server 22.

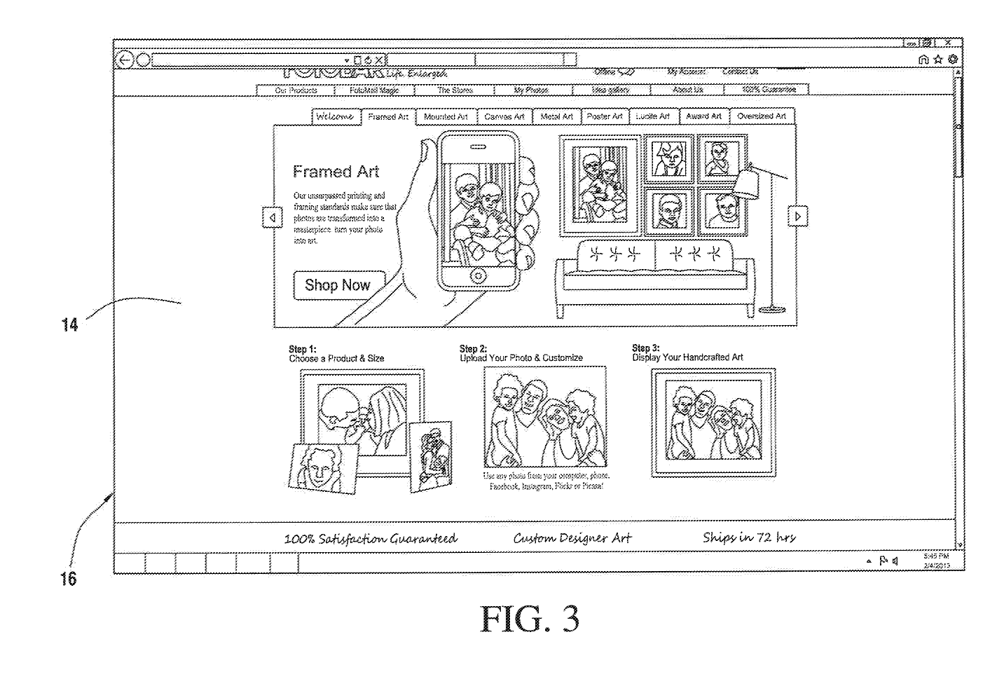

With this underlying structure in mind, the present system 10 operates in the following manner. A user 28 of the present system 10 navigates to webpage upon which the present system 10 operates (see FIG. 3). For the purposes of this disclosure it will be referred to as the “E-mail a photo” website. The user 28 will then be required to establish an account (if not already a member) and login into the system 10. Creation of an account establishes a user account 44 that is maintained on the database 34 of the web server 22. Login is achieved in a conventional manner by entering a name, email address and password. It is appreciated other mechanisms for login may be employed within the spirit of the present invention.

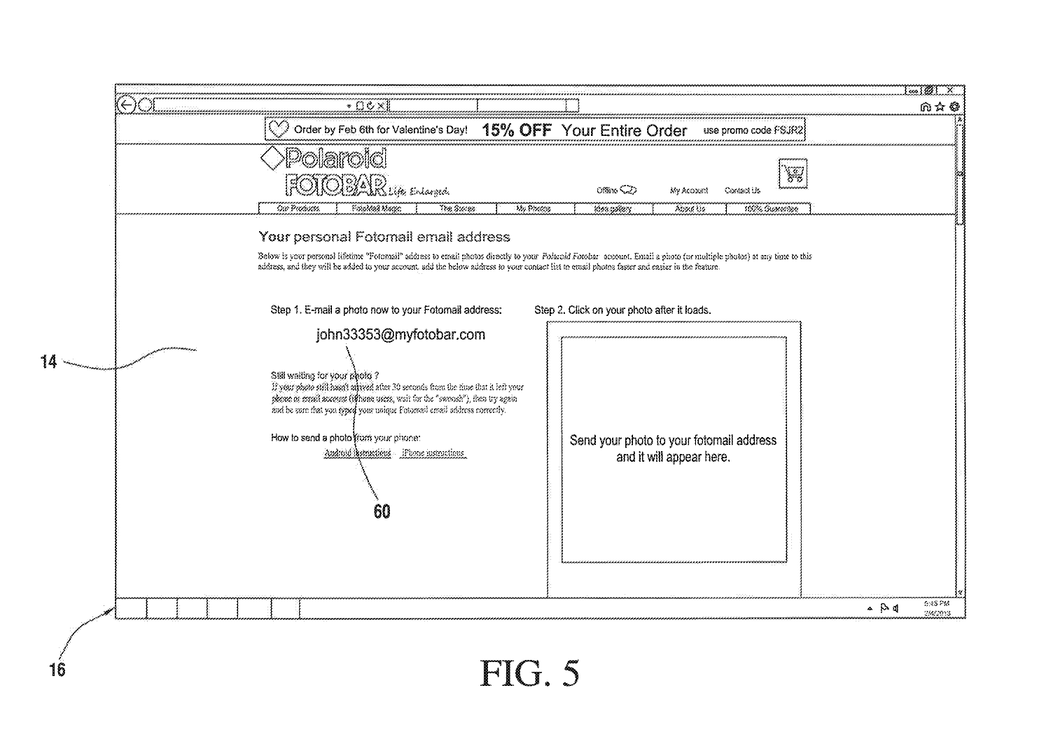

Once login is complete, the user 28 either “surfs” the site looking at objects 20 he or she might wish to purchase or begin the process by sending a digital image 12 to incorporate into an object 20. For the purposes of disclosure, the user will first send the digital image 12 and subsequently incorporate it into an object 20. As is shown in FIG. 5, the digital image 12 may be sent via various means including but not limited to a phone or email, computer, system account, FACEBOOK ® etc.

Upon setting up an account, and with reference to FIG. 6 the web server 22 generates a unique email address 60 that is presented to the user 28. As will be explained below, he user 28 may send their digital images 12 to this unique email address 60 for real-time viewing. In accordance with a preferred embodiment, the unique email address 20 is composed of the user's first name and the user's account number (generated by the system), ending with the proper domain (for example, joe12345@asite.com). The user 28 is instructed to send the file(s) (that is, the digital images 12) they would like to add/view to this email address 60 using any email client on their smartphone, computer or other device.

The file(s) are sent with the attached image(s) 12 to the unique email address 60 using the SMTP protocol. However, no inbox is created at the SMTP server 26 for the unique email address. As such, the email message, along the attached digital image(s) 12, is received with by the SMTP server 26, but no email address is available to complete delivery thereof. As such, the SMTP server 26, upon arrival of the email, considers the email to an invalid “to address” and the email is sent to the “catch-all” email account 50 which receives all email for that domain that does not match an existing email account.

The scheduled (cron 52) job initiates a background process on the web server 22 which checks the “catch-all” email account 50 every few seconds for any new emails. If SMTP server 26, through the scheduled job, finds an email with a “to address” that matches a user's account number (recall the “to address” contains the user's account number) the SMTP server 26 then proceeds to further checks to see if the email has any valid digital image file(s) attached, such as a .jpg file(s). If so, the attached digital image file(s) are downloaded from the SMTP server 26 to the web server 22, and saved to the appropriate user account 44 maintained on the database 34 of the web server 22. The user account 44 is then updated with the downloaded image 12 which is shown to the user 28 as shown in FIG. 7.

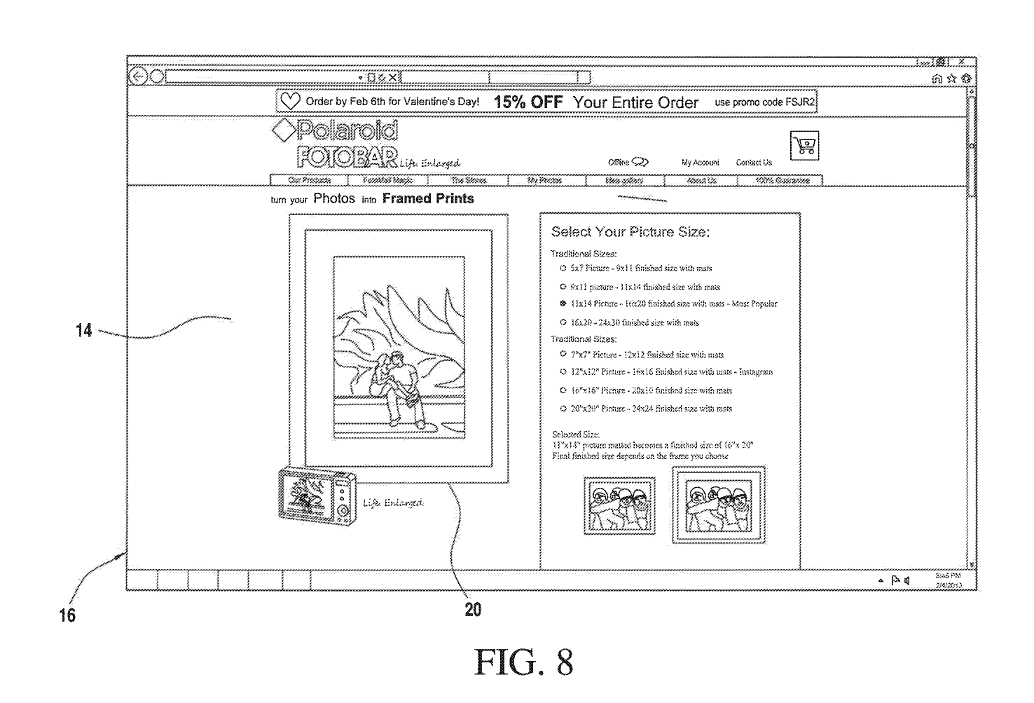

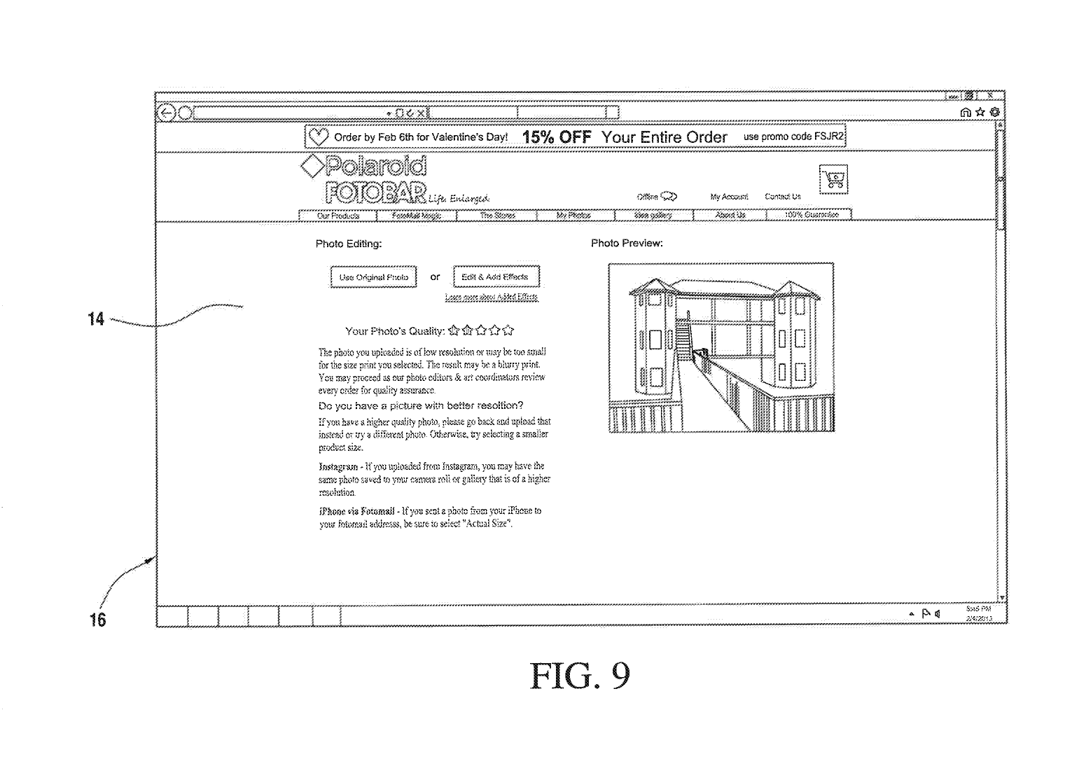

Referring to FIG. 8, the user may then proceed to surf the site for objects 20 he or she might wish to integrate with the image 12. As mentioned above, these objects 20 may include mugs, picture frames, travel cups, banners, etc; in fact, any physical object upon which a user might wish to have a digital image 12 reproduced. Once an object is identified (see FIG. 9) and while the user 28 is still on the “E-mail a photo” website, the website continuously makes RPC (remote procedure call) calls to the database 34 of the web server 22 to retrieve information from the database 34 on any newly added photos to that user account 44. If it finds any new photo information, it obtains the image URL and creates the HTML DOM elements to display the digital image 12.

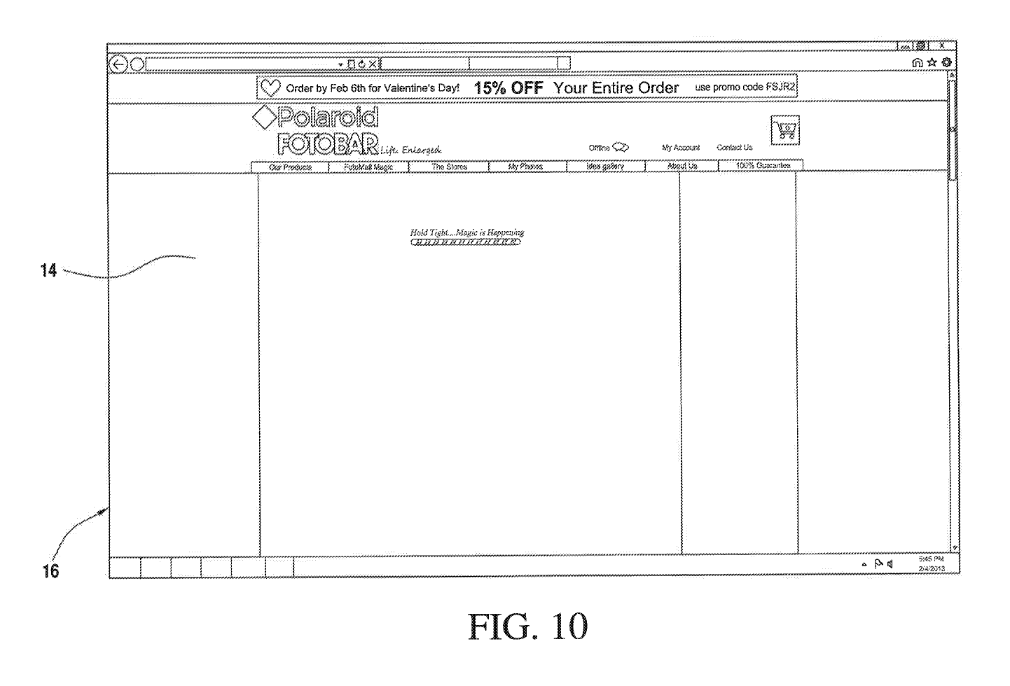

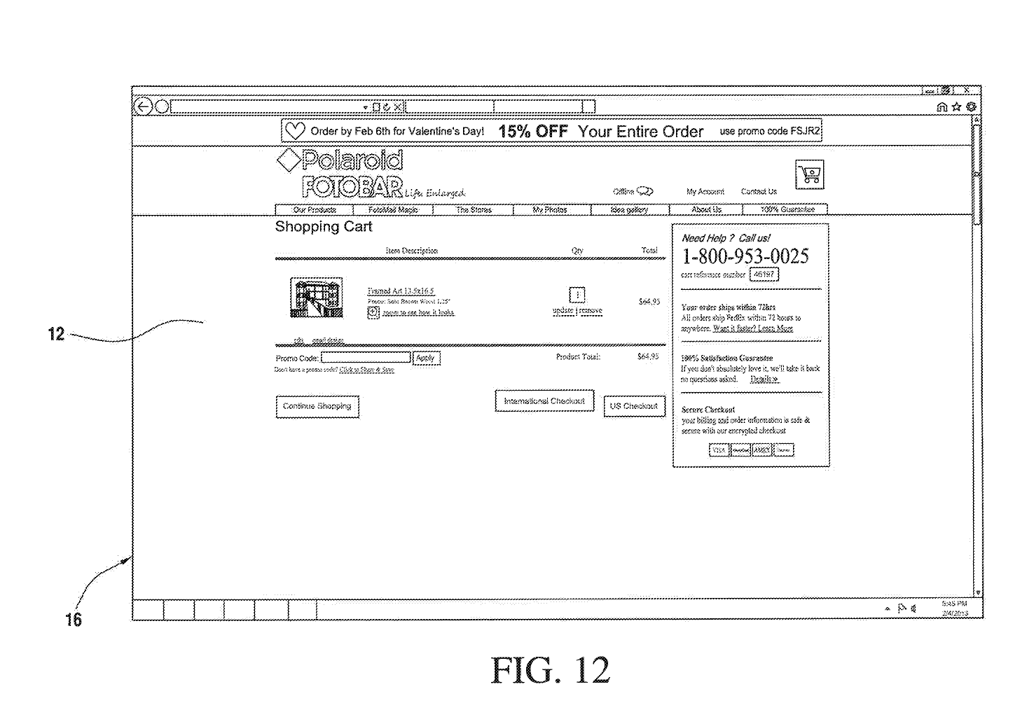

Referring to FIG. 10, with the related digital image 12 displayed the user 28 is provided an opportunity to edit the digital image 12. Once editing is complete, the digital image 12 is processed (see FIG. 11) and is shown in conjunction with the object 20 on the “E-mail a photo” webpage in real-time using JavaScript (see FIG. 11). The user 28 thus sees the digital image they provided displayed in conjunction with the object 20 on the webpage one by one as they are processed. The entire process takes under a minute in most cases. Finally, the user 28 is given the option of purchasing the object 20 with the digital image 12 (see FIG. 12)

While the preferred embodiments have been shown and described, it will be understood that there is no intent to limit the invention by such disclosure, but rather, is intended to cover all modifications and alternate constructions falling within the spirit and scope of the invention.

1. A system for the real-time display of images, comprising:
a web server accessed by a plurality of users via a global communication network, the web server having an IP address associated with a domain; the web server comprising an email address generator providing a unique email address to which a user may send digital images;
a mail server receiving email messages, the mail server including a “catch-all” email account receiving all email for the IP address that does not match an existing email account of the domain and a time based job scheduler initiating checks for any new emails within the “catch-all” email account;
means for identifying emails addressed to the unique email address and determining if the email has any valid digital image file attached thereto;
means for downloading any valid digital image files from the mail server to the web server for viewing by the user on the webpage in real time.

2. The system according to claim 1, wherein users view images upon a graphic user interface of a browser being run upon a computing device.

3. The system according to claim 1, wherein the viewing by the user on the webpage is upon an object displayed upon the webpage.

4. The system according to claim 1, wherein the object is a picture frame.

5. The system according to claim 1, wherein the web server includes hardware, a database, an operating system, web server software, TCP/IP protocols and site content.

6. The system according to claim 5, wherein within the database of the web server are maintained various user accounts associated with the unique email addresses generated by the email address generator of the web server.

7. The system according to claim 6, wherein the user accounts also maintain data relating to the objects selected for viewing by the user.

8. The system according to claim 1, wherein mail server is an SMTP server.

9. The system according to claim 1, wherein the mail server includes a time based job scheduler initiating checks for new emails within the “catch-all” email account.

10. A method for real-time display of images, comprising:
receiving, by a web server, a request to view images on a website;
generating a unique email address associated with a user account and providing the unique email address to a user wishing to view images on a website;
receiving, by a mail server, an email addressed to the unique email address including images;
downloading the images from the mail server to the web server and associating the images with the user account for viewing on the website.

11. The method according to claim 10, wherein users view images upon a graphic user interface of a browser being run upon a computing device.

12. The method according to claim 10, wherein viewing on the website is in conjunction with an object.

13. The method according to claim 10, wherein the object is a picture frame.

14. The method according to claim 10, wherein the web server includes hardware, a database, an operating system, web server software, TCP/IP protocols and site content.

15. The method according to claim 14, wherein within the database of the web server are maintained various user accounts associated with the unique email addresses generated by the email address generator of the web server.

16. The method according to claim 15, wherein the user accounts also maintain data relating to the objects selected for viewing by the user.

17. The method according to claim 10, wherein mail server is an SMTP server.

18. The method according to claim 10, wherein the mail server includes a time based job scheduler initiating checks for new emails within the “catch-all” email account.
